(19) United States
(12) Patent Application Publication
(10) Pub. No.: US 2024/0177248 A1
(43) Pub. Date: May 30, 2024

(54) Spot Date App

(71) Applicant: Eli Farhadovich-Shalinski, Newtown, PA (US)

(72) Inventor: Eli Farhadovich-Shalinski, Newtown, PA (US)

(21) Appl. No.: 18/457,985

(22) Filed: Aug. 29, 2023

Related U.S. Application Data
(60) Provisional application No. 63/385,483, filed on Nov. 30, 2022.

(51) Int. Cl. G06Q 50/00

(52) U.S. Cl. CPC G06Q 50/01; G06F 3/0483

(57) ABSTRACT

The present invention is a dating app that brings people together who are in the same establishment. When using the app, a check-in option is available upon arrival. Once inside, the app shows and matches other app users who are located in the same establishment and are ready to meet. A match occurs when two app users select each other to match with. After matching, each party can see the list of other people they are matched with. Thereafter, any party can start chatting with any person on their matched list. If, during the chat, either party no longer desires to continue chatting, either party has the option to un-match with that particular party. Further, the app provides a safety feature where the user can alert a contact thought the application. Additionally, the app can be displayed in multiple languages, giving users from around the world access to the app.

### FIELD OF THE INVENTION

The present invention relates generally to a method and system for connecting and matching users in an electronic dating service. More specifically, the present invention is a dating app that brings people together who happen to be in the same establishment.

### BACKGROUND OF THE INVENTION

In the past, the most common form of dating involved meeting a person for the first time and striking up a conversation. Oftentimes, both individuals shared a mutual friend, which made the interaction less awkward. Over the years, the dating game has changed dramatically. Traditional dating still exists, but technology in computers, cell phones, and social media has paved the way for online dating. Online dating provides many more opportunities to find a potential partner as compared to meeting someone in person for the first time. Dating apps, in particular, allow users to create a user profile that includes information about themselves, such as their age, interests, and life goals. This allows other app users to look at the profile and decide whether they want to get to know that person before meeting face-to-face. In effect, online dating eliminates the awkward interaction of meeting someone for the first time. Both potential dates can learn more about the other simply by reviewing each other's profile and seeing if they share common interests. This makes it easier when contacting the individual for the first time and starting a conversation. To make it easier to find a potential date, some dating apps include a match making feature. Typically, match making apps select a potential partner for the user, based on common interests shared between both users.

However, online dating does have its disadvantages. For instance, the overwhelming number of potential dates can make the dating game confusing, causing some individuals to endlessly look for the perfect partner. Also, some individuals on dating apps misrepresent themselves, posting pictures that do not accurately depict their current appearance. Another disadvantage is that online dating cannot replace the experience of meeting a person, face-to-face, for the first time. An in-person meeting allows both individuals to communicate more effectively through tone of voice and body language, which are harder to replicate through a computer screen. Thus, an in-person meeting makes it easier for both individuals to connect and determine if there is instant chemistry. Lastly, and most important, online dating can be time consuming and may never lead to an in-person date due to both individuals being at different locations while chatting online.

An objective of the present invention is to provide a solution to the aforementioned problems. More specifically, it is an aim of the present invention to combine all the benefits of online dating (e.g., no awkward first interaction), but with an opportunity to meet the other person, face to face, right after. The present invention is a mobile software application (app) that provides real-time opportunities and experience of the dating world. The difference between this app and other dating apps is that this app provides real-time dating in a particular establishment between parties. The app gives a higher chance for users to actually meet in-person at the same time and same spot in the location they have been matched. Thus, the app brings people together who happen to be in the same dance room, bar, club, bar-restaurant, or any other entertainment establishment. The purpose of the app is to act as a “wingman” or “icebreaker,” by preventing person-to-person interaction inside an establishment that could make the other party uncomfortable and cause unwanted consequences. The app brings the old fashion dating world, which is face-to-face, in person, and modern dating tools to get to know each other. The app helps people to match and connect in a much easier way and avoid the awkwardness between parties and dismiss any unwanted interactions in person.

### SUMMARY OF THE INVENTION

The present invention is a dating app that brings people together who happen to be in the same entertainment establishment. When using the app, a check-in option is available upon arrival. Once inside, the app shows and matches other app users who are located in the same establishment and are ready to meet. Unlike other dating apps, matching happens only inside of a particular establishment, and not through social media nor anywhere outside of the establishment. In particular, matching happens by the person's appearance and not by common interests. A match occurs when two app users select each other to match with. After matching, each party can see the list of other people they are matched with. Thereafter, any party can start chatting with any person on their matched list. During a chat, it will be up to both parties to decide when to approach each other based on their comfort level. They can chat as long or as little as they desire. During the chat, both parties have the option of taking an instant picture. If, during the chat, either party no longer desires to continue chatting, either party has the option to un-match with that particular party. Once unmatched, both parties will not be able to see and text each other. Further, the app provides a safety feature where the user can alert a contact thought the application, if something seems suspicious or unsafe. Additionally, the app can be displayed in multiple languages, giving users from around the world access to the app.

### BRIEF DESCRIPTION OF THE DRAWINGS

FIG. 1 is a schematic view showing the overall system of the present invention.

FIG. 2 is a flowchart depicting the overall process of the present invention.

FIG. 3 is a flowchart depicting the continuation of the overall process of the present invention.

FIG. 4 is a flow diagram of the present invention illustrating the overall method of connecting and matching with another user on the application of the present invention.

FIG. 5 is an illustration of an embodiment of the present invention showing the log-in/sign-up screen of the application of the present invention.

FIG. 6 is an illustration of an embodiment of the present invention showing the sign-up screen of the application of the present invention.

FIG. 7 is an illustration of an embodiment of the present invention showing a home page according to the present invention.

FIG. 8 is an illustration of an embodiment of the present invention showing the settings screen of the application of the present invention.

FIG. 9 is an illustration of an embodiment of the present invention showing a personal profile page of a user account according to the present invention.

FIG. 10 is an illustration of an embodiment of the present invention showing a browse page for establishments according to the present invention.

FIG. 11 is an illustration of an embodiment of the present invention showing user list page in an establishment, according to an alternated embodiment of the present invention.

FIG. 12 is an illustration of an embodiment of the present invention showing the selection of an interested user profile page, according to the present invention.

FIG. 13 is an illustration of an embodiment of the present invention showing a connection page, according to the present invention.

FIG. 14 is an illustration of an embodiment of the present invention showing the messaging screen of the application of the present invention.

### DETAIL DESCRIPTIONS OF THE INVENTION

All illustrations of the drawings are for the purpose of describing selected versions of the present invention and are not intended to limit the scope of the present invention.

The present invention is a mobile software application (app) that provides real-time dating opportunities and the experience of the dating world. More specifically, the present invention is a dating app that brings people together who happen to be in the same dance room, bar, club, bar-restaurant, or any other entertainment establishment.

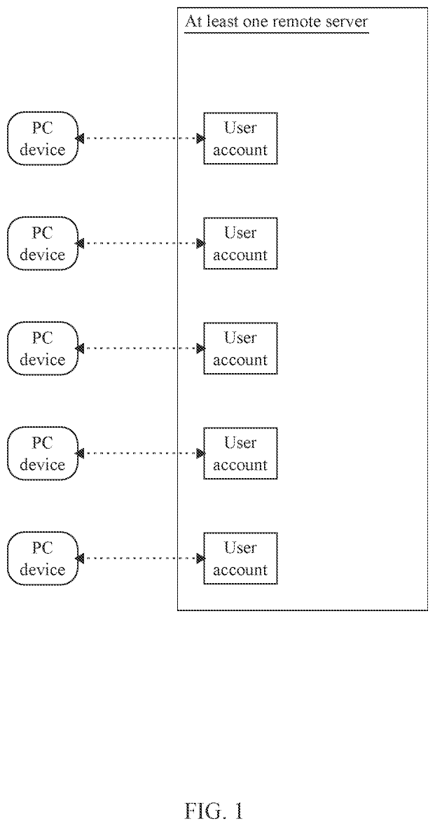

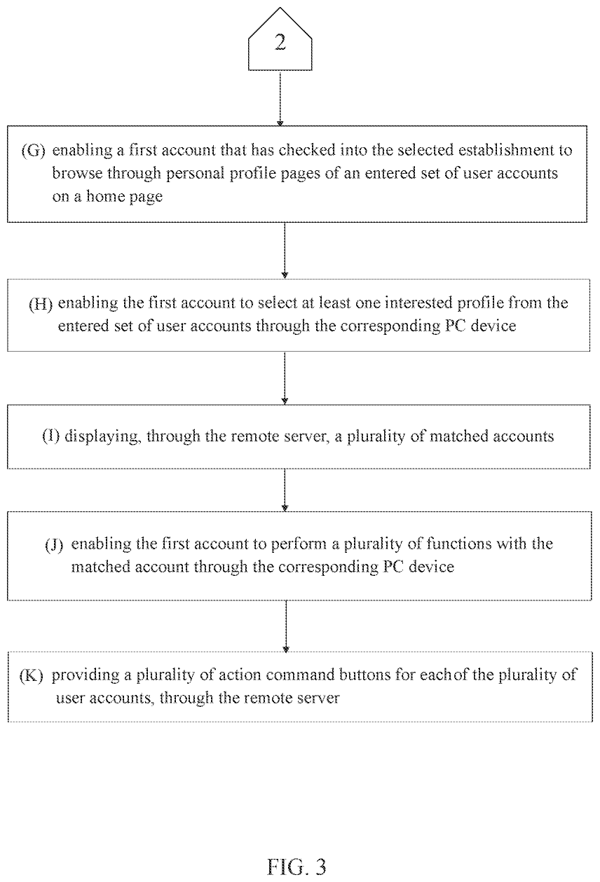

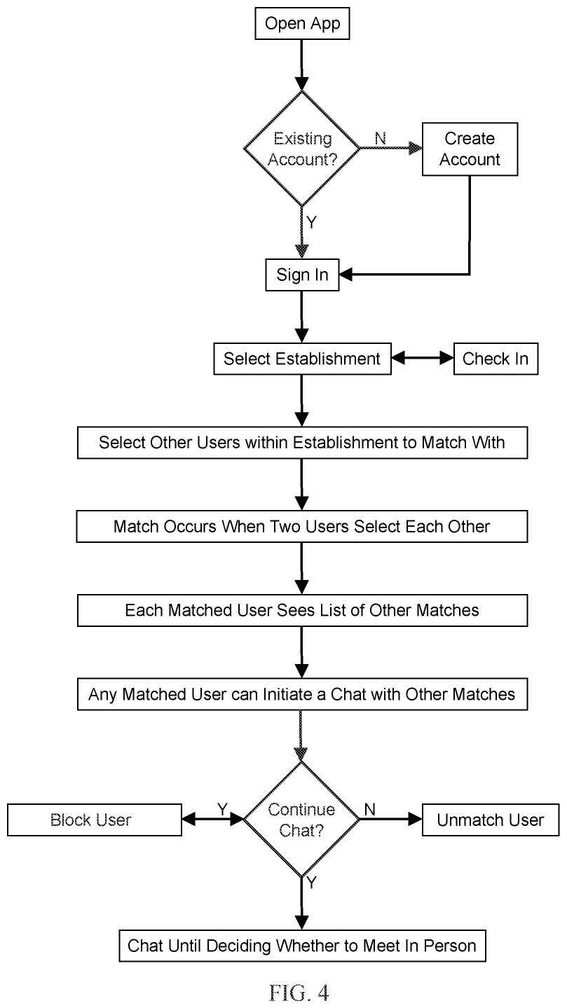

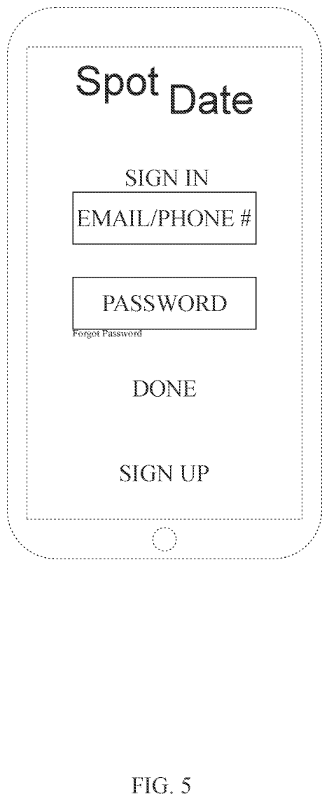

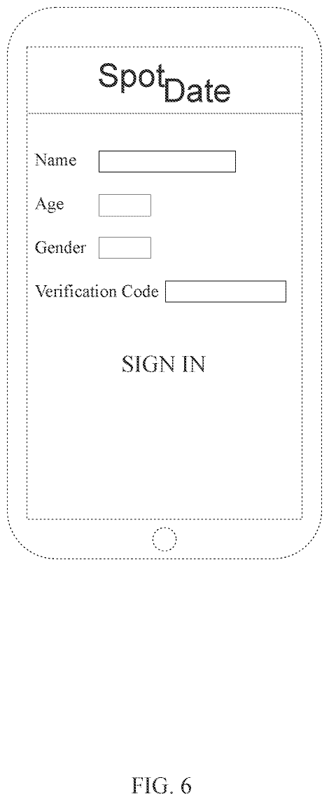

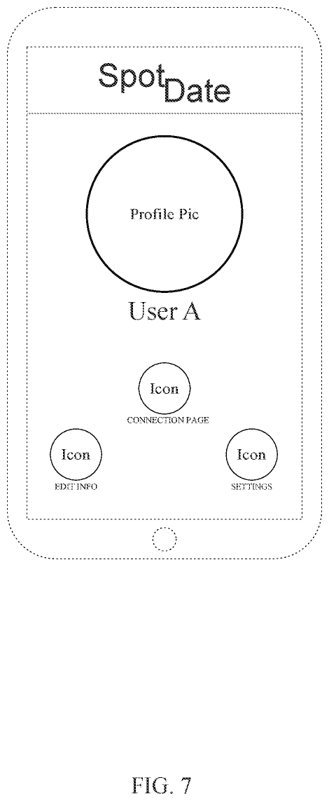

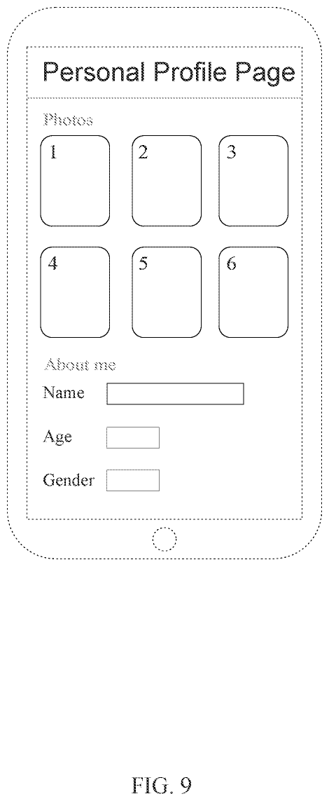

The following description is in reference to FIG. 1 through FIG. 14. As can be seen in FIG. 1, the system used to implement the method of the present invention is provided with a plurality of user accounts managed by at least one remote server (Step A). Each of the plurality of user accounts is associated with a corresponding user personal computing (PC) device. In the preferred embodiment, each of the plurality of user accounts is tied to a single user who is able to interact, participate, and operate the corresponding user PC device while implementing the present invention. The user interface (for example, a display screen of the corresponding PC device) of the user-side application provides people with the ability to create a user account, and then use that user account to check into establishments and the browse through people who are already in the establishment and who are using the application. The corresponding user PC device allows a user to interact through the present invention and can be, but is not limited to, a smartphone, a laptop, a desktop, or a tablet PC. To that end, the present invention works on operating systems, mobile applications, and/or may be embedded into websites. The remote server is where the user account is stored and is also used to facilitate data transformations and interactions between the plurality of user accounts.

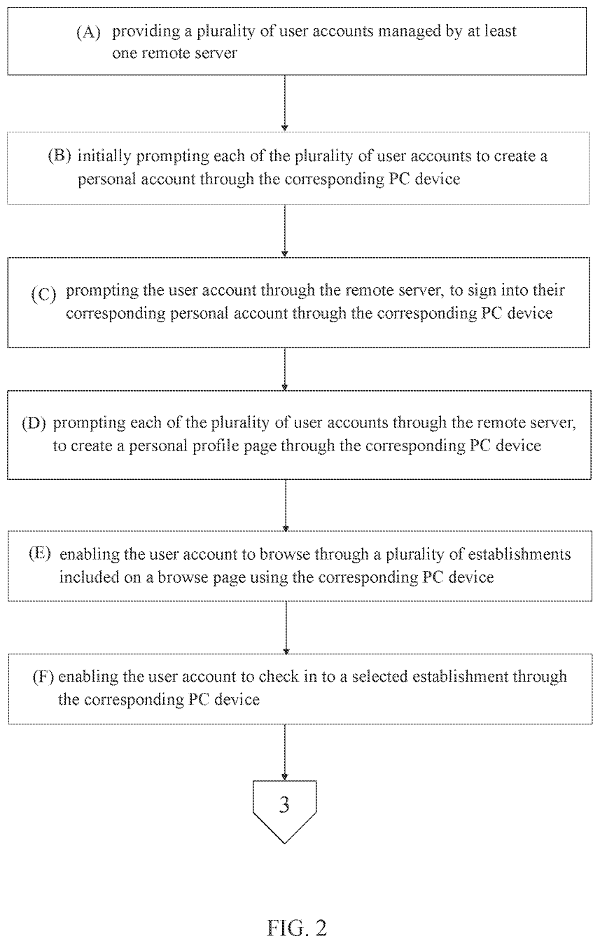

In order to accomplish the above-mentioned functionalities, the overall method of the present invention begins by initially prompting each of the plurality of user accounts to create a personal account through the corresponding PC device (Step B), wherein the personal account is associated with the plurality of user accounts. In other words, creating a personal account is the first step a user using the application has to go through in order to use the present invention. More specifically, creating the personal account includes the steps of, but not limited to, selecting a country, entering a valid phone number, entering an OTP (one time passcode), agreeing to a privacy policy document, etc. As can be seen in FIG. 1 and FIG. 2, the app allows an individual to sign-in to an existing account. Accordingly, the overall method of the present invention continues by prompting the user account through the remote server, to sign into their corresponding personal account through the corresponding PC device (Step C). In other words, the app allows individuals (users) to create an account and/or sign-in to the app using information provided during the account creation. Subsequently, the overall method of the present invention continues by prompting each of the plurality of user accounts through the remote server, to create a personal profile page through the corresponding PC device (Step D). Preferably, creating the personal profile page comprises entering personal details using the corresponding PC device, wherein the personal details include, but are not limited to photos, name, age, gender, etc. Of the personal photos uploaded, the user may designate one photo as the user's profile picture. However, creating the personal account and the personal profile page may include entering any other information or credentials, as long as the intents of the present invention are not altered.

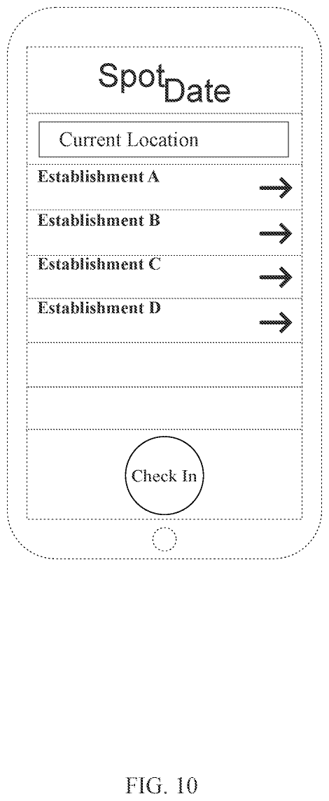

In the preferred embodiment, after the user's account is properly set up, the app provides a location screen or browse page, which allows the user to select the location of the establishment that the user wants to be at or is currently at. To that end, the overall method of the present invention continues by enabling the user account to browse through a plurality of establishments included on a browse page using the corresponding PC device (Step E). Subsequently, once the user arrives and enters an establishment, the user can input the name of the establishment in the app. Accordingly, the overall process continues by enabling the user account to check in to a selected establishment through the corresponding PC device (Step F), wherein the selected establishment is from the plurality of establishments. In other words, the user can then select the establishment that the user is currently present in. In addition, as seen in FIG. 10, a “Check In” icon can be selected which notifies other users within the establishment that said user is currently present at the same establishment.

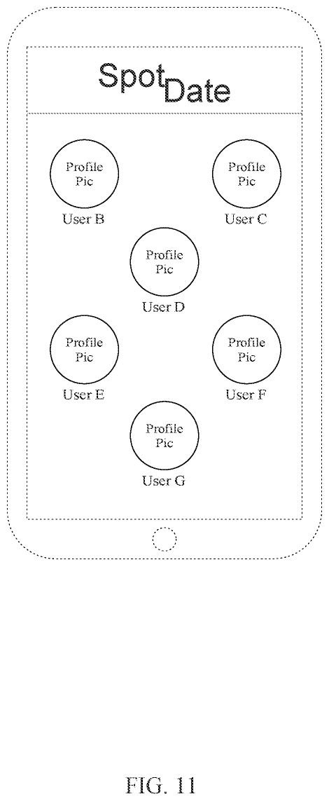

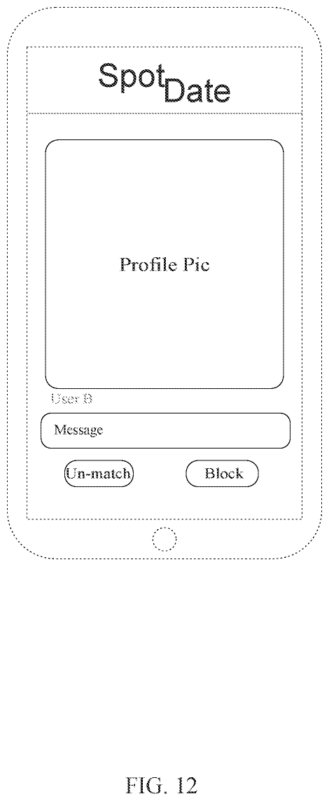

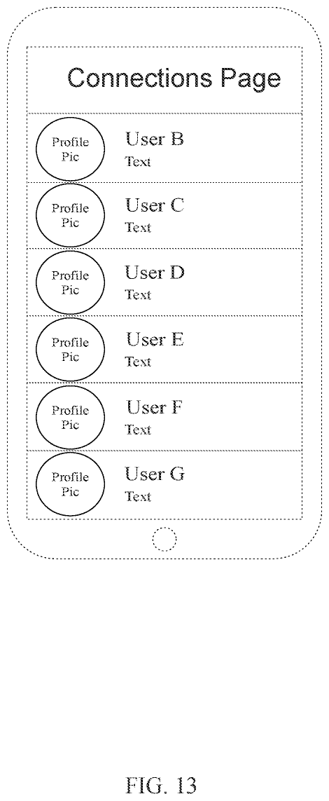

In the preferred embodiment, the app provides a main screen for selecting preferred matches. As can be seen in FIG. 11, after the user designates the establishment, a main screen of the app displays a list of other users within the same establishment who are ready to meet. To that end, the overall process of the method continues by enabling a first account that has checked into the selected establishment to browse through personal profile pages of an entered set of user accounts on a home page, wherein the entered set of user accounts have already checked into the selected establishment, and wherein the entered set of user accounts and the first account are from the plurality of user accounts (Step G). For example, the user can then browse through the list, view another user's profile information, and select one or more users to match with, as illustrated in FIG. 12. Accordingly, the overall method continues by enabling the first account to select at least one interested profile from the entered set of user accounts through the corresponding PC device (Step H). In other words, the user who checked into the establishment first browses through a plurality of other user accounts who have already checked into the establishment. After browsing through the profiles, the user may select or express interest in one or more user profiles that the user finds matching, by clicking on a button and notifying that user. A match occurs when two users select each other to match with. Thus, the overall process continues by displaying, through the remote server, a plurality of matched accounts, wherein each of the plurality of matched accounts is generated when the first account and a second account select each other as interested profiles, wherein the second account is from the entered set of user accounts (Step I). More specifically, if the first account and the second account who are present within the establishment opens the application and select each other's profiles or expresses interest in each other's profiles, then a match happens, and the application displays those two accounts as a match or matched accounts. As can be seen in FIG. 13, after the app determines a match, the app displays a list of other users that said user is matched with. In the preferred embodiment, selecting an interested profile from the entered set of user accounts includes graphically clicking on a handwave notification sign that is associated with each of the plurality of user accounts. However, any other method of selecting a profile or expressing interest in a profile may be employed, as long as the intents of the present invention are not altered.

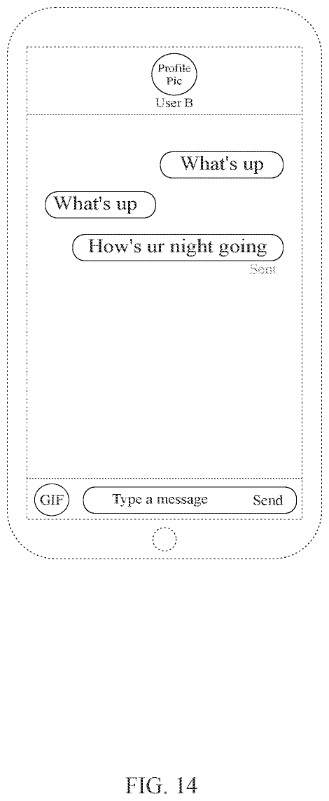

Continuing with the preferred embodiment, the overall process continues by, enabling the first account to perform a plurality of functions with the matched account through the corresponding PC device (Step J). Preferably, the plurality of functions includes, but are not limited to initiating a chat, ending a chat, sending pictures, blocking a matched account, unmatching an account, etc. In other words, as seen in FIG. 12 and FIG. 14, said user or any other user that said user is matched with can initiate a chat. For example, assume said user is user A. User A is matched with user B and user C. In this example, user A can initiate a chat with user B and/or user C. Alternatively, user B and/or user C can initiate a chat with user A.

It is an aim of the present invention to enable switching of operations and control between various users, pages, and functionalities for the user. Accordingly, the overall process of the present invention continues by providing a plurality of action command buttons for each of the plurality of user accounts, through the remote server (Step K). In other words, the present invention provides a plurality of short cut buttons that enable each of the user accounts to perform certain functions or go to certain pages within the application. It should be noted that the plurality of action command buttons may be positioned on any page, and/or or any location on the page of the present invention, as long as the intents of the present invention are not altered.

In reference to FIG. 13, a subprocess of the present invention comprise the steps of providing a connection page, wherein the connection page displays the matched profiles, chat records, and activity of the user account already checked into the selected establishment. For example, if user A is matched with user B and user C, the connection page of user A displays user B and user C as matched profiles, and the connection page would also have tabs that enables user A to initiate chat with both user B and user C as well as chat history and activity of user A within the establishment. Further, the subprocess continues by enabling the user account to go to the connection page, by graphically clicking a connection page icon by the corresponding PC device, wherein the connection page icon is from the plurality of action command buttons. In other words, the user can switch between the connection page and the home page with the click of a button.

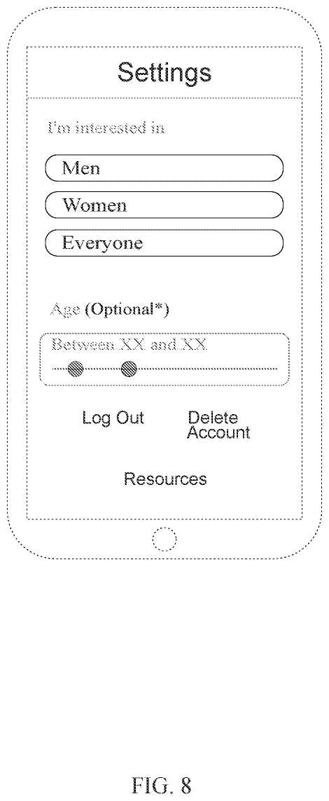

According to the preferred method of the present invention, a subprocess of the present invention comprises the steps of providing a settings sign on the home page through the remote server, wherein the settings sign is from the plurality of action buttons. Further, the subprocess continues by enabling the user account to go to a settings page, by graphically clicking on the settings sign. Preferably, the settings page enables the user account to perform important actions associated with the working of the application. As seen in FIG. 8, the settings page displays details including, but not limited to, interested gender selection option, delete account option, log out option, resources etc. More specifically, by going to the settings page, the user can select the interested gender of choice, can log out of the establishment, change a setting related to the display, sound, etc. pertaining to the application.

In reference to FIG. 10, a subprocess of the present invention comprises the steps of providing a search button on the browse page through the remote server. This is so that the search button enables the user account to search for an establishment through the search button displayed on the corresponding PC device. For example, after the user's account is properly set up, the app provides a browse page, which allows the user to select the location of the establishment that the user is currently at. Once the user arrives and enters an establishment, the user can input the name of the establishment in the app. Specifically, as seen in FIG. 10, the browse page or location screen displays one or more icons, including but not limited to, a “Current Location” icon. Selecting the “Current Location” icon enables the device's native locations services to be shared with the app. In turn, the location screen displays one or more establishments within close proximity to the user's current location.

According to the preferred embodiment, the user can browse through a plurality of user accounts who have already checked into the establishment. Accordingly, a subprocess of the present invention comprises the steps of swiping up and down though the home page through the corresponding PC device, to display the entered set of user accounts. Further, the sub process continues by swiping left and right along the personal profile page of a corresponding account through the corresponding PC device, to display photos of the corresponding account, wherein the corresponding account is from the first set of user accounts. In other words, swiping up and down along the home page will display the list of user accounts who have checked into the establishment, and swiping left and right along a user profile displays details and photos of that specific user profile.

Continuing with the preferred embodiment, a sub-process of the present invention comprises the steps of enabling the user account to log out from the selected establishment by graphically clicking on a logout button through the corresponding PC device. As seen in FIG. 8, at any point during the user's presence within the establishment, the user can log out from the selected establishment with the click of a button on the application. However, according to the present invention, following log out, all the activity and chat history of the user account at the selected establishment will be completely removed from the application. In other words, once you sign out of an establishment, all conversations you had with other users at the establishment are erased. Thus, the present invention helps provide a safe and protected environment for people who are looking to connect through the app at a particular location/establishment.

In the preferred embodiment, a subprocess of the overall method provides an un-match button through the remote server. In other words, the present invention provides the option of enabling the user account to un-match a matched user account by graphically clicking on the un-match button through the corresponding PC device, wherein unmatching removes the matched user account from the user account's profile. More specifically, if at any time during the chat one party no longer desires to continue chatting, then said party can choose to un-match with the other party, as seen in FIG. 1 and FIG. 12. Once unmatched, both parties can no longer see or chat with each other on the app. Alternatively, if both parties prefer to continue chatting, the chat can continue for as long or as little as they desire. It is up to both parties to decide when to approach each other in person, based on their comfort level.

In an alternate embodiment, a subprocess of the method of the present invention provides a block button through the remote server. Further, the subprocess enables the user account to block a matched user account by graphically clicking on the block button through the corresponding PC device, wherein blocking a matched user account removes the matched user account from being displayed in the application. More specifically, the block button blocks that person from view throughout the app, not just the particular venue.

In an alternate embodiment, a subprocess of the method of the present invention provides a plus sign through the remote server, wherein the plus sign is from the plurality of action buttons. Further, the subprocess continues by enabling the user account to enter details of a new establishment through the corresponding PC device, by graphically clicking on the plus sign through the corresponding PC device.

In an alternate embodiment, a subprocess of the method of the present invention provides an emergency button through the remote server. Further, the subprocess continues by enabling the user account to contact an emergency contact by clicking on the emergency button through the corresponding PC device and enabling the user account to send a notification signal to the emergency contact by clicking on the emergency button through the corresponding PC device. In other words, the present invention helps provide emergency contact in case one partner has bad intentions. Before going out on a date, a user can send a notification to a close friend or family member, providing them information about the person he/she is going out with (profile pic of the interested user account). Further, another safety feature of the present invention prevents users from taking screen shots of profiles and chat records while using the app. To that end, taking a screen shot after checking into the selected establishment displays a black screen, according to the present invention.

In another embodiment, the app provides the ability to send an instant picture. In this embodiment, at any time during the chat, either party can send an instant picture to the other party. The purpose of the instant picture is to provide a most recent picture of one party, which can be viewed by the other party. Alternatively, the instant picture can be used as a frame of reference, showing the general location of one party within the establishment. As a result, the instant picture feature can assist both parties in deciding whether to continue chatting or to meet in person.

In another embodiment, the app can be displayed in multiple languages. This allows users from around the world to access the app. The app is preferably provided as a mobile application, but can also be provided as different embodiments including, but not limited to, software applications, cloud applications, etc. The app can be installed on mobile devices connected to the Internet, such as smartphones.

Although the invention has been explained in relation to its preferred embodiment, it is to be understood that many other possible modifications and variations can be made without departing from the spirit and scope of the invention.

1. A method for connecting and matching users who are present at a same establishment, the method comprising the steps of:
(A) managing a plurality of user accounts by at least one remote server, wherein each user account is associated with a corresponding personal computing (PC) device;
(B) initially prompting each of the plurality of user accounts to create a personal account through the corresponding PC device, wherein the personal account is from the plurality of user accounts;
(C) prompting the user account through the remote server, to sign into their corresponding personal account through the corresponding PC device;
(D) prompting each of the plurality of user accounts through the remote server, to create a personal profile page through the corresponding PC device;
(E) enabling the user account to browse through a plurality of establishments included on a browse page through a user interface displayed on a display screen of the corresponding PC device;
(F) enabling the user account to check in to a selected establishment through the corresponding PC device, wherein the selected establishment is from the plurality of establishments;
(G) enabling a first account that has checked into the selected establishment to browse through personal profile pages of an entered set of user accounts on a home page, wherein the entered set of user accounts have already checked into the selected establishment, and wherein the entered set of user accounts and the first account are from the plurality of user accounts;
(H) selecting at least one interested profile from the entered set of user accounts for the first account through the user interface on the display screen of the corresponding PC device;
(I) displaying, through the remote server, a plurality of matched accounts, wherein each of the plurality of matched accounts is generated in response to the first account and a second account selecting each other as interested profiles on their corresponding PC devices, wherein the second account is from the entered set of user accounts;
(J) enabling the first account to perform a plurality of functions with the matched account through the corresponding PC device, wherein the plurality of functions includes, but are not limited to initiating a chat, ending a chat, sending pictures, blocking each other, etc.; and
(K) providing a plurality of action command buttons for each of the plurality of user accounts, through the remote server.

2. The method as claimed in claim 1, wherein creating the personal account includes the steps of, but not limited to, selecting a country, entering a valid phone number, entering an OTP (one time passcode), agreeing to a privacy policy document, etc.

3. The method as claimed in claim 1, wherein creating the personal profile page comprises entering personal details using the corresponding PC device, wherein the personal details include, but are not limited to photos, name, age, gender, etc.

4. The method as claimed in claim 1, wherein selecting an interested profile from the entered set of user accounts includes graphically clicking on a handwave notification sign that is associated with each of the plurality of user accounts.

5. The method as claimed in claim 1 comprising the steps of:
providing a connection page, wherein the connection page displays the matched profiles, chat records, and activity of the user account already checked into the selected establishment; and
enabling the user account to go to the connection page, by graphically clicking a connection page icon by the corresponding PC device, wherein the connection page icon is from the plurality of action command buttons.

6. The method as claimed in claim 1, comprising the steps of:
providing a settings sign on the home page through the remote server, wherein the settings sign is from the plurality of action buttons; and
enabling the user account to go to a settings page, by graphically clicking on the settings sign.

7. The method as claimed in claim 6, wherein the settings page displays details including, but not limited to, interested gender selection option, delete account option, log out option, resources etc.

8. The method as claimed in claim 1, comprising the steps of:
providing a search button on the browse page through the remote server; and
enabling the user account to search for an establishment search through the search button through the corresponding PC device.

9. The method as claimed in claim 1, comprising the steps of:
swiping up and down though the home page through the corresponding PC device, to display the entered set of user accounts; and
swiping left and right along the personal profile page of a corresponding account through the corresponding PC device, to display photos of the corresponding account, wherein the corresponding account is from the first set of user accounts.

10. The method as claimed in claim 1, comprising the steps of:
providing a logout button through the remote server;
enabling the user account to log out from the selected establishment by graphically clicking on a logout button through the corresponding PC device; and
removing all activity and chat history of the user account at the selected establishment following log out.

11. The method as claimed in claim 1, comprising the steps of:
providing a plus sign through the remote server, wherein the plus sign is from the plurality of action buttons; and
enabling the user account to enter details of a new establishment through the corresponding PC device, by graphically clicking on the plus sign through the corresponding PC device.

12. The method as claimed in claim 1, comprising the steps of:
providing an un-match button through the remote server; and
enabling the user account to un-match a matched user account by graphically clicking on the un-match button through the corresponding PC device, wherein unmatching removes the matched user account from the user account's profile.

13. The method as claimed in claim 1, comprising the steps of:
providing a block button through the remote server; and
enabling the user account to block a matched user account by graphically clicking on the block button through the corresponding PC device, wherein blocking a matched user account removes the matched user account from being displayed in the application.

14. The method as claimed in claim 1, comprising the steps of:
providing an emergency button through the remote server;
enabling the user account to contact an emergency contact by clicking on the emergency button through the corresponding PC device; and
enabling the user account to send an notification signal to the emergency contact by clicking on the emergency button through the corresponding PC device.

15. The method as claimed in claim 1, wherein taking a screen shot after checking into the selected establishment displays a black screen.

16. A method for connecting and matching users who are present at a same establishment, the method comprising the steps of:
(A) managing a plurality of user accounts by at least one remote server, wherein each user account is associated with a corresponding personal computing (PC) device;
(B) initially prompting each of the plurality of user accounts to create a personal account through the corresponding PC device, wherein the personal account is from the plurality of user accounts;
(C) prompting the user account through the remote server, to sign into their corresponding personal account through the corresponding PC device;
(D) prompting each of the plurality of user accounts through the remote server, to create a personal profile page through the corresponding PC device;
(E) enabling the user account to browse through a plurality of establishments included on a browse page through a user interface displayed on a display screen of the corresponding PC device;
(F) enabling the user account to check in to a selected establishment through the corresponding PC device, wherein the selected establishment is from the plurality of establishments;
(G) enabling a first account that has checked into the selected establishment to browse through personal profile pages of an entered set of user accounts on a home page, wherein the entered set of user accounts have already checked into the selected establishment, and wherein the entered set of user accounts and the first account are from the plurality of user accounts;
(H) selecting at least one interested profile from the entered set of user accounts for the first account through the user interface on the display screen of the corresponding PC device;
(I) displaying, through the remote server, a plurality of matched accounts, wherein each of the plurality of matched accounts is generated in response to the first account and a second account selecting each other as interested profiles on their corresponding PC devices, wherein the second account is from the entered set of user accounts;
(J) enabling the first account to perform a plurality of functions with the matched account through the corresponding PC device, wherein the plurality of functions includes, but are not limited to initiating a chat, ending a chat, sending pictures, blocking each other, etc.; and
(K) providing a plurality of action command buttons for each of the plurality of user accounts, through the remote server, wherein the action command buttons include, but are not limited to, a connections page icon, a settings page icon, a personal profile page icon, etc.

17. The method as claimed in claim 1 comprising the steps of:
providing a connection page, wherein the connection page displays the matched profiles, chat records, and activity of the user account already checked into the selected establishment;
enabling the user account to go to the connection page, by graphically clicking a connection page icon by the corresponding PC device, wherein the connection page icon is from the plurality of action command buttons.

18. The method as claimed in claim 16, comprising the steps of:
providing a logout button through the remote server;
enabling the user account to log out from the selected establishment by graphically clicking on a logout button through the corresponding PC device, wherein the log out button is from the plurality of action command buttons;
removing all activity and chat history of the user account at the selected establishment following log out.

19. The method as claimed in claim 1, comprising the steps of:
providing an un-match button through the remote server;
enabling the user account to un-match a matched user account by graphically clicking on the un-match button through the corresponding PC device, wherein unmatching removes the matched user account from the user account's profile.

20. The method as claimed in claim 1, comprising the steps of:
providing a block button through the remote server;
enabling the user account to block a matched user account by graphically clicking on the block button through the corresponding PC device, wherein blocking a matched user account removes the matched user account from being displayed in the application.
